(19) United States
(12) Patent Application Publication
(10) Pub. No.: US 2011/0241552 A1
(43) Pub. Date: Oct. 6, 2011

(54) METHOD FOR MAXIMIZING THE PERFORMANCE OF A LUMINAIRE

(75) Inventors: Berend J. W. Ter Weeme, Eindhoven (NL); Theodoor C. Treurniet, Best (NL); Wido Van Duijneveldt, Geldrop (NL); Erwin D. Stinstra, Den Bosch (NL)

(73) Assignee: KONINKLIJKE PHILIPS ELECTRONICS N.V., EINDHOVEN (NL)

(21) Appl. No.: 13/139,065

(22) PCT Filed: Dec. 7, 2009
(86) PCT No.: PCT/IB09/55532

§ 371 Date: Jun. 10, 2011

(30) Foreign Application Priority Data
Dec. 12, 2008 (EP) 08171464.4

(51) Int. Cl. H05B 37/02

(52) U.S. Cl. 315/152; 315/297

(57) ABSTRACT

A method for maximizing the performance of a luminaire (1) emitting light is provided, which method comprises determining a target color point (T) corresponding to a predetermined color, providing a first light source (2) emitting light at a fixed reference color point (W), and providing a second light source (4) being able to emit light at an adjustable color point (RGB). Said adjustable color point (RGB) is selected such that a combination of light emitted by the first and the second light sources (2, 4) together produces light at the target color point (T), wherein the adjustable color point (RGB) is selected based on the position of the target color point (T) and the reference color point (W) for maximizing the performance of the luminaire (1).

With the provision of a solution in accordance with the present invention, fewer computations need to be performed in order to maximize the illumination performance of the luminaire (1).

### FIELD OF THE INVENTION

The present invention relates to a method for maximizing the performance of a luminaire emitting light at a predetermined color. The present invention likewise relates to such a luminaire, a computer program for performing such a method, and a computer program product.

### DESCRIPTION OF THE RELATED ART

Advances in the development and improvement of the luminous flux of light-emitting devices, for instance LEDs, have made these devices suitable for use in general illumination applications. For illumination, it is usually important to have high luminous efficiency and/or good color rendering. Color Rendering Index (CRI) is a quantitative measure of the ability of a light source to reproduce the colors of various objects faithfully in comparison with an ideal or natural light source. The CRI is a CIE (International Commission on Illumination) scale used to indicate the color rendering accuracy of a light source compared to a reference source of the same color temperature, and is usually the average for eight standard colors, Ra₈. Expressed on a scale of 1 to 100, a value of 100 indicates no distortion. A low CRI rating indicates that the color of objects will appear distorted under that particular light source.

An adjustable color lighting system, such as a luminaire, is typically constructed by using a number of primary colors. For a luminaire made up of a respective red, green and blue LED, a huge variety of colors may be provided, and a unique combination of the LEDs intensities will give a particular color. W O2008/056321, for instance, relates to a method for determining drive values for driving a lighting device at a desired brightness and color. Although a system of three LEDs is depicted, WO 2008/056321 additionally mentions the use of a wide-band (phosphor-converted) white LED or an amber LED used together with narrow-banded red, green and blue LEDs. While a CRI of up to approximately 89 is reachable when mixing three colors, mixing four colors may lead to CRI values somewhere between 85 and 98, which will meet most needs of general lighting. Should five colors be mixed, a slightly larger CRI value may be reached.

The different illumination characteristics may be calculated based on a number of numerical, mathematical or experimental methods using known, calculated (e.g. interpolated, simulated, extrapolated etc.) or measured illumination characteristics of the test reference sources. These comparisons usually involve complex functions, and consequently some computational effort. If more than three colors shall be mixed, the computational effort resulting from known algorithms may become impractical, and thus complex. Therefore, for simplifying the control of for example a luminaire, it may be desirable to simplify the calculation of different illumination characteristics.

### SUMMARY OF THE INVENTION

It is therefore an object of the present invention to provide a solution in which the above-related drawbacks are at least partly eliminated.

According to a first aspect of the invention, the above object is met by a method for maximizing the performance of a luminaire emitting light at a predetermined color, comprising determining a target color point corresponding to the predetermined color, providing a first light source emitting light at a fixed reference color point, and providing a second light source being able to emit light at an adjustable color point. The method further comprises selecting said adjustable color point such that a combination of light emitted by the first and the second light sources together produces light at the target color point, wherein the adjustable color point is selected based on the position of the target color point and the reference color point for maximizing the performance of the luminaire.

By essentially coupling degrees of freedom such that light to be emitted is divided into two sets, i.e. one set representing the first light source and one set representing the second light source, which sets are coupled by the explicit relation, the number of degrees of freedom may be reduced. For instance, the second light source may comprise a plurality of light sources, such as for example three light sources adapted to emit respective red, green and blue light. Accordingly, fewer computations are needed for maximizing the performance of the luminaire.

The maximization of the performance may comprise maximizing at least one of a color rendering index (CRI), flux and efficacy of the luminaire. Which illumination characteristics to be maximized may for instance be predefined in the luminaire, or be selectable through a user interface, and may differ from one luminaire to another, or even from one time to another utilizing the same luminaire, depending on the occasion.

According to one embodiment, the second light source comprises at least three tunable light sources of different primary colors. With the provision of at least three tunable primary colors, the intensity ratios of the tunable light sources and the first light source may be tuned to provide the predetermined, desired target color point at a maximized performance. The explicit relation between the parameters given by the present invention enables the number of degrees of freedom to be reduced from four to three, namely to the desired color, the first light source and the second light source reflecting all three tunable light sources. Furthermore, with the tunable light sources being of different primary colors, a wide range of colors may be supported. The tunable light sources may for instance be a respective red, green and blue narrow banded tuning light source, whereby generation of saturated colors may be supported in an efficient manner. The light sources according to the invention may furthermore be for instance LEDs (light emitting diodes), the scope is however not restricted thereto.

In order to in an efficient manner be able to tune the luminaire to provide the predetermined color, the first light source may be adapted to provide essentially white light. “Essentially white” should throughout the document be interpreted in a broad sense, likewise comprising multiple variants of white light sources providing for instance cool white, warm white, or a combination of the two whites, as well as amber. The white light source may for instance be a wide-band phosphor-converted LED, or an amber LED, although other options naturally are feasible, such as the white light source being represented by three primary LEDs which colors are mixed to produce white light.

In order to identify the desired color at which light should be emitted from the luminaire, selection of the predetermined color may be based on a target color input value acquired by means of a predetermined setting and/or a user interface. Thereby different options are provided for selection of the target color point, and the extent of the possibilities may be for the designer to judge.

Initial reference and/or primary color points may be known from initial calibration of the luminaire of from nominal values. In order to identify an updated reference color point and/or the primary color point, measurement values from one or a combination of at least one temperature sensor, at least one color sensor and at least one flux sensor may be acquired, and the reference color point and/or the primary color points hence determined based on the measurement values. With such feedback abilities, color points reflecting the current circumstances may be retrieved by the luminaire, and measures to adapt to those circumstances may be performed. Initial values are for instance stored within the luminaire, and updated in accordance with the measurements during operation.

According to one embodiment, tunable driving signals for the second light source may be adapted to provide the adjustable color point, a first driving signal for the first light source adapted to provide the reference color point, and the light sources hence driven at the respective driving signals. Consequently, the luminaire may thus comprise means, such as a regulator, to adjust the driving signals of the different light sources by for instance changing the respective duty cycles and/or current levels.

In order to realize a color space conversion, the target color point, the reference color point and adjustable color point may be mapped to a chromaticity diagram expressed in a two dimensional space. The adjustable color point is preferably situated along an extension of a straight line imagined between the reference color point and the target color point. Such a two dimensional space may for instance be represented by a CIE (International Commission of Illumination) color space chromaticity diagram, preferably CIE 1931 (xyY). With the forced condition of positioning the second light source along the straight line, the possible selectable coordinates for the second light source in the dimensional space are restricted to be on or, in the vicinity of, that line.

According to one embodiment, a coupling factor derived from comparison of the target color point, the reference color point and the adjustable color point may be determined for at least one light combination emitted by the first and the second light sources which together produces light at the target color point. Furthermore, an adjustable color point represented by an outstanding coupling factor may be selected out of the combinations. Thereby, an implementation of how the degrees of freedom may be restricted is presented, with the use of the explicit algorithm identifying an outstanding, for instance the highest, coupling factor.

In order to avoid real-time computation efforts within the luminaire, the adjustable color point may be selected from a look-up table comprising pre-stored data. With such a solution, parts of the computation efforts may be performed offline in advance, and the complexity of the luminaire hence be reduced.

Accordingly, it is possible to provide a solution with an explicit relation between the predetermined color point, the reference color point and the adjustable color point, which in a practical manner by reducing the number of degrees of freedom, reduces the number of computations needed for maximization of the luminaire.

According to a second aspect, a luminaire for maximizing the performance at a predetermined color is provided, comprising means for determining a target color point corresponding to a predetermined color, a first light source emitting light at a fixed reference color point, and a second light source being able to emit light at an adjustable color point. The luminaire further comprises means for selecting said adjustable color point such that a combination of light emitted by the first and the second light sources together produces light at the target color point, wherein the adjustable color point is selected based on the position of the target color point and the reference color point for maximizing the performance of the luminaire. With such a luminaire, similar effects as described in conjunction with the first aspect of the invention may be accomplished.

According to a third aspect of the present invention, a computer program product is provided, comprising a computer readable medium having stored thereon computer program means for causing a control unit to maximize the performance of a luminaire emitting light at a predetermined color. The computer program product comprises code for determining a target color point corresponding to a predetermined color, code for providing a first light source emitting light at a fixed reference color point, and code for providing a second light source being able to emit light at an adjustable color point. The computer program product further comprises code for selecting said adjustable color point for light emitted by the second light source such that a combination of light emitted by the first and the second light sources together produces light at the target color point, wherein the adjustable color point is selected based on the position of the target color point and the reference color point for maximizing the performance of the luminaire. The computer program product of the third aspect may also provide similar effects as described in conjunction with the first aspect of the invention. Additionally, a computer program is provided, for performing the steps of the method when the program is executed in a control unit for a luminaire.

### BRIEF DESCRIPTION OF THE DRAWINGS

These and other aspects of the present invention will now be described in more detail, with reference to the appended drawings showing currently preferred embodiments of the invention, in which:

FIG. 1 illustrates an exemplifying luminaire for maximizing the performance at a predetermined color in accordance with an embodiment of the present invention.

FIG. 2 illustrates a color space chromaticity diagram expressed in a two dimensional space, depicting the color points of the embodiment in an exemplifying manner.

FIG. 3 presents exemplifying steps for maximizing the performance of the luminaire of the embodiment.

### DETAILED DESCRIPTION OF CURRENTLY PREFERRED EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

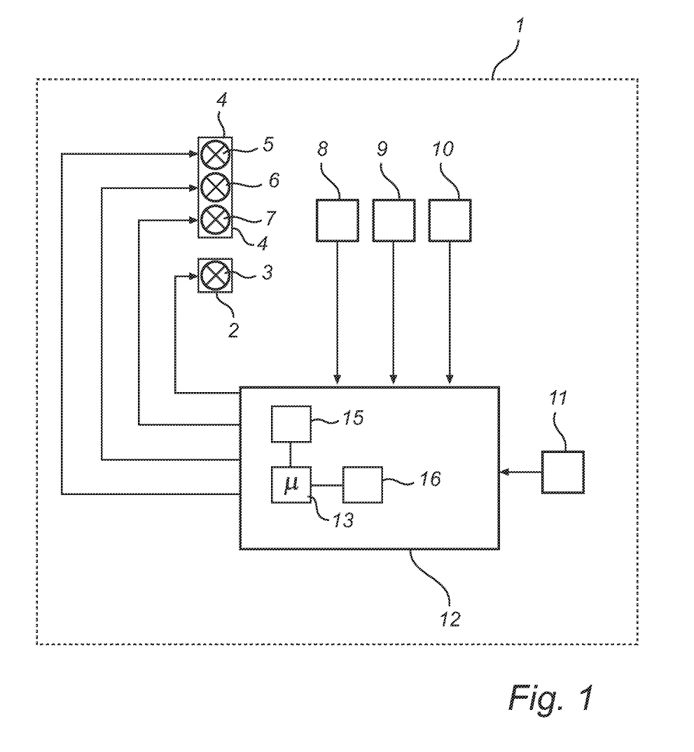

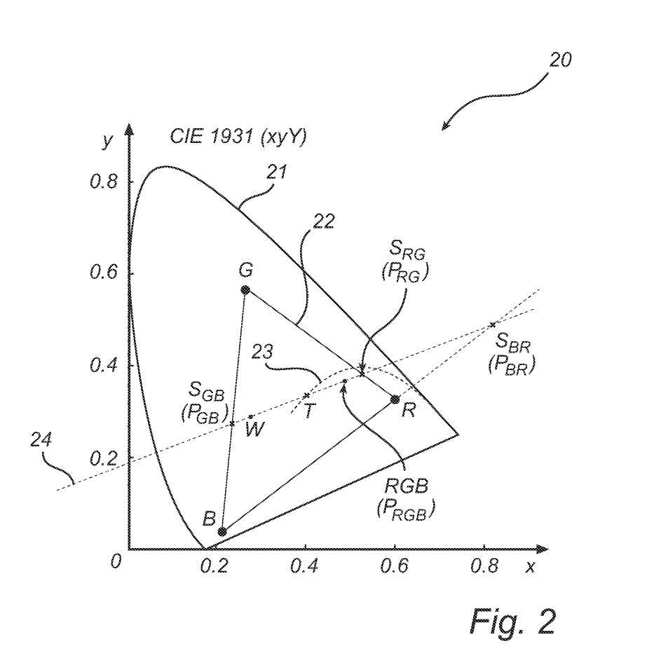

FIG. 1 illustrates an exemplifying luminaire 1 for maximizing the performance at a predetermined color in accordance with an embodiment of the present invention. In the illustration, provided with the luminaire 1, is a first light source 2 depicted, which here comprises a single LED 3 adapted to emit essentially white light. The white LED 3 may for instance be a wide-band phosphor-converted LED, or an amber LED, although other options naturally are feasible. The white LED 3 may for instance likewise be represented by two or more primary LEDs, which colors are mixed to produce white light. Alternatively, wider-band LEDs may provide good color rendering, and although not currently available, such wider-band LEDs are encompassed as sources for light sources described herein. The luminaire 1 may furthermore be provided with a second light source 4, for example comprising tunable LEDs 5, 6, 7. The tunable LEDs are in the shown embodiment a red (R) 5, a green (G) 6 and a blue (B) 7 LED, adapted to emit light at a respective different primary color R, G, B, which will be further explained in conjunction with FIG. 2. The scope of the invention naturally covers other combinations of LEDs, emitting other colors than those suggested, and not necessarily being primary. It should furthermore be noted, that in other embodiments, further light sources may be provided in addition to the first and second 2, 4.

The luminaire 1 may furthermore comprise a temperature sensor 8 which may be mounted in proximity to the differently colored LEDs 3, 5, 6, 7. The temperature sensor 8 may be adapted to determine a surrounding temperature and/or a substrate temperature of the LEDs 3, 5, 6, 7. Additionally, a color sensor 9 may be provided. The color sensor 9 is a sensor adapted to give the color coordinates (e.g. CIE X,Y) of the emitted light, i.e. to measure the color coordinate of the white and/or the individual primary R, G, and B colors. Also, a flux sensor 10 adapted to give a single flux number of the emitted light may thus be used with a drive- and measurement scheme which allows to determine red, green and blue fluxes separately. The sensitivity of the flux sensor 10 preferably resembles the human eye sensitivity. It should be noted that the above mentioned sensors 8, 9, 10 respectively are provided in the vicinity of the light sources 2, 4 to provide measurement values for a luminous flux and/or color for each of the differently colored LEDs 3, 5, 6, 7. Possibly, one or all of the sensors 8, 9, 10 may be omitted, as well as the use of additional sensors.

In order to support selection of various colors at which the luminaire 1 should emit light and/or selection of which characteristics should be prioritized for maximization of performance, the luminaire 1 may furthermore comprise a user interface 11. The user interface 11 may include user input devices such as buttons and adjustable controls, which produce a signal or voltage, for instance a digital signal corresponding to a high and a low digital state. If the voltage is in the form of an analog voltage, an analog to digital converter (A/D) may be used to convert the voltage into a useable digital form (not shown). Via the user interface 11, a user may be able to select a desired color, and/or select for which characteristics the luminaire 1 should be maximized; for instance the user may choose to select maximized CRI, flux or efficacy of the luminaire 1. The luminaire 1 may be optimized to find the best possible trade-off between for instance a large system efficacy usually quantified as a large luminous efficacy, and good color rendering properties usually quantified as large CRI. Alternatively or additionally, the desired color and/or characteristics to be maximized may likewise be predetermined and/or retrieved from settings within the luminaire 1.

In the depicted embodiment is furthermore a control unit 12 provided, which may be adapted to receive measurement values from the sensors 8, 9, 10 and the predetermined color and/or preferred performance characteristics from the user interface 11. The control unit 12 may comprise a microprocessor, microcontroller, programmable digital signal processor or another programmable device; each of them represented by the reference number 13. The control unit 12 may also, or instead, include an application specific integrated circuit, a programmable gate array, programmable array logic, a programmable logic device, or a digital signal processor. Should the control unit 12 comprise a programmable device such as the microprocessor or microcontroller mentioned above, the processor 13 may further include computer executable code that controls operation of the luminaire 1. The control unit 12 may additionally comprise a regulator 15, which enables duty cycles and or current levels for one or several of the LEDs 3, 5, 6, 7, to be adjusted.

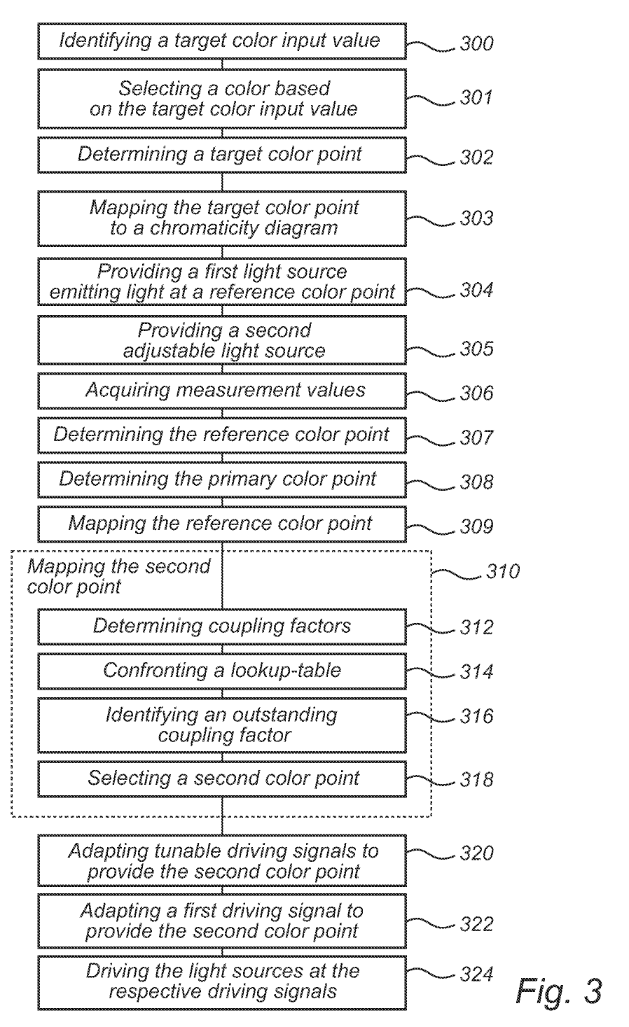

According to the illustrated embodiment, the luminaire 1 furthermore comprises a look-up table 16, where data may be pre-stored. The advantages of the look-up table 16 along with functionality of the luminaire 1 will be described in further detail in the following, in conjunction with FIGS. 2 and 3.

FIG. 2 illustrates a color space chromaticity diagram 20 expressed in a two dimensional space, depicting color points denoted W, T, RGB of the embodiment in an exemplifying manner The outer horseshoe-shaped curve 21 corresponds to the colors of the visible spectrum (color points of monochromatic light). For the color space conversion, for example a CIE to RGB color space conversion, matrix calculations and/or retrieval of pre-calculated values from the look-up table 16 may be needed as described in FIG. 3.

FIG. 3 presents exemplifying steps for maximizing the performance of the luminaire 1 of the shown embodiment. The steps may for instance be performed by a computer program, when executed in the control unit 12 of the luminaire. It should be noted that some of the following steps may be performed in another order than suggested, or even simultaneously.

In use, the color at which the luminaire 1 should provide light needs to be determined Thus, in a first step 300, a target color point input value representing a desired set point may be identified. In the described embodiment, this value is retrieved from the user interface 11, however the skilled addressee realizes that the value likewise may be derived from for instance another electrical system, or from predetermined settings. In step 301, a color may be selected, which is based on the retrieved target color input value.

Next in step 302, a target color point, T, corresponding to the predetermined color may be determined In step 303, the target color point T may be mapped to the chromaticity diagram 20. The two dimensional space may for instance be represented by the commonly known CIE (International Commission of Illumination) color space chromaticity diagram, preferably CIE 1931 (xyY). Should maximized performance include maximization of CRI, the target color point T is preferably selected along the black body line 23.

In step 304, a first light source 2 is preferably provided, which light source 2 may be adapted to emit light at a fixed reference color point, W. In the illustrated embodiment, the LED 3 of the first light source 2 is a white LED, and is thus adapted to provide white, or essentially white, light. It should be emphasized that the reference color point W likewise may be provided by implementation of two or more primaries, i.e. by two or more differently colored LEDs.

In step 305, a second light source 4 is preferably provided. As previously indicated, in the depicted embodiment a respective tunable red, green and blue LED 5, 6, 7 are comprised within the adjustable light source 4, adapted to provide light at respective different primary colors. The primary colors are denoted R, G, B, and forms a triangle 22 that preferably surrounds the target color point T. Should there be more than three LEDs comprised in the second light source 4, the corresponding primary color points form a polygon by interconnection of adjoining primary color points.

As the LEDs 3, 5, 6, 7 are affected by for instance ambient temperature and aging, their respective color points W, R, G, B tend to drift in the color space 20. Thus, in step 306, in order to identify the current positions of the reference color point W and primary color points R, G, B, measurement values from one or a combination of at least one temperature sensor 8, color sensor 9 and flux sensor 10 are preferably acquired. Subsequently, in step 307 and 308 respectively, the reference color point W and the primary color points R, G, B reflecting the current conditions may be determined, and in step 309, the reference color point W may be mapped to the chromaticity diagram 20. Note that alternatively or additionally to retrieving measurement values (step 306) to update the values of the color points W, R, G, B, initial predetermined values known from nominal values or from calibration of the luminaire 1, may be utilized.

In step 310, mapping of the adjustable color point RGB to the chromaticity diagram 20 may be performed. The adjustable color point RGB is preferably situated along an extension of a straight line 24 imagined between the reference color point W and the target color point T. This mapping may be performed by in step 312 determining coupling factors P for at least one light combination emitted by the first and the second light sources 2, 4, which together produces light at the target color point T. Coupling factors P may be derived from comparison of the target color point T, the reference color point W and the adjustable color point RGB. In the shown embodiment, P is derived by mapping the primary color points R, G, B to the chromaticity diagram 20, defining the triangle 22, and defining boundary intersection points, denoted S_{RG}, S_{GB}, S_{BR}, in the chromaticity diagram 20 where the straight line 24 imagined between the reference color point W and the target color point T, in its extensions, crosses boundaries of the triangle 22.

In step 314 respective boundary coupling factors P_{RG}, P_{GB}, P_{BR} for the boundary intersection points S_{RG}, S_{GB}, S_{BR} may be determined along with coupling factors P for different light combinations emitted by the first and the second light sources 2, 4, for instance by confronting a look-up table 16. In step 316, an outstanding coupling factor P is identified out of the tried combinations, in the shown embodiment the highest coupling factor P_{RGB} detected which lies within the triangle 22. In step 318, the corresponding color point may be selected as the adjustable color point RGB, whereby the combination of light emitted by the first and second light sources 2, 4 together produces light at the target color point T, at feasible maximized performance of the luminaire 1.

Should the theoretically ideal adjustable color point RGB lie outside the triangle 22 which represents physical boundaries, the luminaire 1 may not be able to reach this value and the ideal color point RGB may hence not be feasible. In such a case, the boundary intersection point S_{RG}, S_{GB}, or S_{BR} having the highest coupling factor P_{RG}, P_{GB}, or P_{BR} may represent the first physical bound encountered, and the corresponding color point S_{RG}, S_{GB}, or S_{BR} may be selected as the adjustable color point RGB. The highest coupling factor P_{RGB} consequently represents the maximized performance with regards to the preferred characteristics such as CRI, flux and/or efficacy, which the luminaire 1 may provide.

The coupling factors P may for instance be derived from the following algorithm:

P=(2X_{T}−(X_{W}+X_{RGB}))/(X_{RGB}−X_{W}), (Eq. 1)

where, X_{T} is defined as the x-coordinate of the target point T, X_{RGB} is the x-coordinate of the total light output of the second light source 4, and X_{W} is the x-coordinate of the total light output of the first light source 2.

In the same manner, the boundary intersection points S_{RG}, S_{GB}, S_{BR} may be determined as follows:

ax+by+c=0, (Eq. 2)

where

a=y_{P}−y_{Q}, (Eq. 3)

b=x_{Q}−x_{P}, (Eq. 4)

c=−ax_{P}−by_{P}, (Eq. 5)

By using these equations with a₁, b₁, c₁ as the line 22 through the reference color point W and the target color point T, and a₂ . . . a₄, b₂ . . . b₄ and c₂ . . . c₄ as the coefficients of the lines through RG, GB and BR respectively, the three intersection points S_{RG}, S_{GB}, S_{BR} may be derived with calculation of the determinants as follows:

$$\begin{matrix}{x}_{Si} = \frac{\vert \begin{matrix}{b}_{1} & {c}_{1} \\ {b}_{j} & {c}_{j}\end{matrix} \vert}{\vert \begin{matrix}{a}_{1} & {b}_{1} \\ {a}_{j} & {b}_{j}\end{matrix} \vert} & ( Eq . 6 ) \\ {y}_{Si} = \frac{\vert \begin{matrix}{c}_{1} & {a}_{1} \\ {c}_{j} & {a}_{j}\end{matrix} \vert}{\vert \begin{matrix}{a}_{1} & {b}_{1} \\ {a}_{j} & {b}_{j}\end{matrix} \vert} & ( Eq . 7 )\end{matrix}$$

where j=2 . . . 4.

The corresponding coupling factors P_{RG}, P_{GB}, or P_{BR} may be derived by:

P_{Si}=(2X_{T}−(X_{W}+X_{Si}))/(X_{Si}−X_{W}). (Eq. 8)

Utilizing the above equations; if the target color point coincides with the reference color, P_{S}=−1. Should the target color point coincide with the adjustable color point RGB, P_{S}=1. By computations and/or simulations according to the above, a relation between the reference color point W, the target color point T and the adjustable color point RGB may thus be deduced in an efficient manner; f(X_{R}, X_{G}, X_{B}, X_{W}, T). As previously stated, it may be preferred to perform some of the computations off-line and store corresponding data in a look-up table 16. A large amount of various combinations of the function f(X_{R}, X_{G}, X_{B}, X_{W}, T) may thereby be calculated in advance, and corresponding coupling factors P may be monitored and stored along with the respective combinations. Mixes of the different colored LEDs 3, 5, 6, 7 with a large luminous efficacy, luminous flux and/or a large CRI, may thus be computed along with corresponding coupling factors P. This may be done in such a way that mixing ratios can be retrieved for any selected color, e.g. by interpolation. There is virtually no limit to the number of colors that can be mixed this way, should these calculations be performed off-line and stored in the look-up table 16.

Having identified the preferred mix of the LEDs 3, 5, 6, 7, the luminaire 1 may be prepared for emitting corresponding light. Thus, in order to implement driving second light source 4 in accordance with the adjustable color point RGB, tunable driving signals for the tunable light sources 5, 6, 7 may in step 320 be adapted, preferably by the regulator 15, to provide the adjustable color point RGB. In step 322, a first driving signal for the first light source 2 may be adapted in a similar manner to provide the reference color point W. Subsequently, in step 324, the light sources 2, 4, may be driven at the respective driving signals. Adapting the driving signals may for instance comprise adjusting duty cycles and/or current levels, as it is known that the human eye integrates the light it receives over a period of time and, even though the current through the LEDs 3, 5, 6, 7 may generate the same light level regardless of pulse duration, the eye will perceive short pulses as “dimmer” than longer pulses. Due to the human eye's visual perception, LEDs 3, 5, 6, 7 may thus be pulse width or duty cycle modulated in order to save power or achieve an apparent higher brightness for a given power input. It might additionally be necessary to regulate e.g. the duty cycles and/or current levels of the LEDs 3, 5, 6, 7 to adjust to changing conditions such as drifting due to ambient temperature or aging. A feedback signal for such a control system may be provided by means of one or several of the sensors 8, 9, 10. In the illustrated embodiment, individual driving signals are depicted for each LED 3, 5, 6, 7 as shown in FIG. 1. However, individual driving signals is not mandatory, and more than one LED could be driven by the same driving signal where feasible.

As described in the foregoing, by utilizing the introduced explicit relation between the target color point T, the reference color point W and the adjustable color point RGB, for instance as defined by the algorithm according to Equation 1, fewer computations needs to be performed in order to maximize the illumination performance of the luminaire 1. By coupling degrees of freedom such that the LEDs 3, 5, 6, 7 are divided into two sets, i.e. one set representing the first light source 2 and one set representing the second light source 4, which sets are coupled by for instance the algorithm according to equation 1, the number of degrees of freedom are consequently reduced. For the illustrated embodiment of four LEDs 3, 5, 6, 7, the number of degrees of freedom is reduced from four to three, namely to the desired color point T, the reference color point W and the adjustable color point RGB.

In the exemplary embodiments of the present invention described above, the light sources 2, 4 comprise LEDs. It would however be possible, and within the scope of the present invention, to use different types of light sources, such as organic light emitting diodes (OLEDs), polymeric LEDs (PLEDs), inorganic LEDs, lasers, or a combination thereof, as well as a wide-band (direct of phosphor converted) LED and wide-band (phosphor converted) white LEDs. Furthermore, combinations with other light sources like TL, CFL are also possible.

Additionally, it should be emphasized that any combination of LED colors can produce a gamut of colors, whether the LEDs are red, green, blue amber, white, orange, UV or other colors. The various embodiments described throughout this specification encompass all possible combinations of LEDs comprised in the luminaire, such that light of varying color, intensity, saturation and color temperature can be produced.

It should be noted that the luminaire furthermore may comprise any number of optical and/or non-optical components to provide a variety of optical effects. These components may include, but are not limited to, one or more reflective surfaces, lenses, diffusers, and the like, used in different combinations to provide a desired effect.

Furthermore, the skilled addressee realizes that the present invention by no means is limited to the preferred embodiments described above. On the contrary, the skilled addressee understands that many modifications and variations are possible and within the scope of the appended claims. Variations to the disclosed embodiments can be understood and effected by the skilled addressee in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

1. A method for maximizing the performance of a luminaire emitting light at a predetermined color, comprising:
determining a target color point corresponding to said predetermined color;
providing a first light source emitting light at a fixed reference color point;
providing a second light source being able to emit light at an adjustable color point; and
selecting said adjustable color point such that a combination of light emitted by the first and the second light sources together produces light at the target color point, wherein the adjustable color point is selected based on the position of the target color point and the reference color point for maximizing the performance of the luminaire.

2. The method according to claim 1, wherein maximizing the performance comprises maximizing at least one of a color rendering index, flux and efficacy of said luminaire.

3. The method according to claim 1, wherein said second light source comprises at least three tunable light sources of different primary colors.

4. The method according to claim 1, further comprising:
adapting tunable driving signals for said second light source to provide said adjustable color pointer;
adapting a first driving signal for said first light source to provide said reference color point; and
driving said light sources at said respective driving signals.

5. The method according to claim 1, further comprising:
mapping said target color point to a chromaticity diagram expressed in a two dimensional space;
mapping said reference color point to said chromaticity diagram; and
mapping said adjustable color point to said chromaticity diagram, said adjustable color point being situated along an extension of a straight line imagined between said reference color point and said target color point.

6. The method according to claim 5, wherein said two dimensional space is represented by a CIE (International Commission of Illumination) color space chromaticity diagram, preferably CIE 1931.

7. The method according to claim 5, further comprising:
determining, for at least one light combination emitted by the first and the second light sources which together produces light at the target color point, a coupling factor derived from comparison of said target color point, said reference color point and said adjustable color point; and
selecting, out of said combinations, an adjustable color point represented by an outstanding coupling factor P_{RGB}.

8. The method according to claim 3, further comprising:
acquiring measurement values from one or a combination of at least one temperature sensor, at least one color sensor and at least one flux sensor; and determining, based on said measurement values, said reference color point and/or said primary color points.

9. The method according to claim 1, further comprising selecting said predetermined color based on a target color input value acquired by means of a predetermined setting and/or a user interface.

10. The method according to claim 7, wherein said adjustable color point is selected from a look-up table comprising pre-stored data.

11. A luminaire for maximizing the performance at a predetermined color, said luminaire comprising:
means for determining a target color point corresponding to a predetermined color;
a first light source emitting light at a fixed reference color point;
a second light source being able to emit light at an adjustable color point; and
means for selecting said adjustable color point such that a combination of light emitted by the first and the second light sources together produces light at the target color point, wherein the adjustable color point is selected based on the position of the target color point and the reference color point for maximizing the performance of the luminaire.

12. The luminaire according to claim 1, wherein said second light source comprises a respective red, green and blue narrow banded tuning light source.

13. The luminaire according to claim 1, wherein said first light source is adapted to provide essentially white light.

14. (canceled)

15. A computer program product comprising a computer readable medium having stored thereon computer program means for causing a control unit to maximize the performance of a luminaire emitting light at a predetermined color, comprising:
code for determining a target color point corresponding to a predetermined color;
code for providing a first light source emitting light at a fixed reference color point;
code for providing a second light source being able to emit light at an adjustable color point; and
code for selecting said adjustable color point such that a combination of light emitted by the first and the second light sources together produces light at the target color point, wherein the adjustable color point is selected based on the position of the target color point and the reference color point for maximizing the performance of the luminaire.
